(19) United States
(12) Patent Application Publication
(10) Pub. No.: US 2001/0020302 A1
(43) Pub. Date: Sep. 13, 2001

(54) Pull-out shower head for kitchen

(75) Inventor: Orlando Bosio, Casaloldo (IT)

Correspondence Address: MODIANO & ASSOCIATI, Via Meravigli, 16, Milano, 20123, IT

(73) Assignee: AMFAG S.p.A.

(21) Appl. No.: 09/797,573

(22) Filed: Mar. 5, 2001

(30) Foreign Application Priority Data
Mar. 10, 2000 (IT) MN2000A000013

(51) Int. Cl. E03C 1/04

(52) U.S. Cl. 4/677

(57) ABSTRACT

A pull-out shower head for kitchens, wherein the water conveyance body comprises a cavity which is arranged substantially transversely to the water delivery direction and has an opening toward a water intake duct and is divided into two portions on opposite sides with respect to the opening; each portion comprises water delivery ports suitable to be connected respectively to the peripheral ports and to the central port of the delivery disk, at least one portion being provided with a hollow plug which comprises a port for connection to the water delivery port that is comprised within the portion, a flow control element being further provided which is connected to an actuation lever.

### BACKGROUND OF THE INVENTION

The invention relates to a pull-out shower head for kitchen.

The great diffusion achieved by so-called shower heads for kitchen is known; said shower heads are connected to a flexible hose so that they can be pulled out from faucets in order to reach distant positions within sinks, as occurs in particular in large kitchens of the professional type, and convey water with the possibility to provide discharge in the form of a central jet or of a peripheral jet by way of a simple maneuver on an appropriately provided device.

One very common form of said shower heads provides for the presence of a substantially cylindrical portion which is connected, at one end, to a water dispensing nozzle, essentially forming a pipe-like shape which entails some problems in terms of handling by the user.

A pull-out shower head which comprises a body whose shape allows a user to grip it easily for comfortable use in professional kitchens has also been proposed; however, it has disadvantageous characteristics owing to a certain complexity in construction and assembly.

### SUMMARY OF THE INVENTION

The aim of the present invention is to provide a pull-out shower head for kitchen which offers maximum comfort in handling and great simplicity in construction and assembly.

This aim is achieved by a kitchen pull-out shower head, according to the invention, comprising a water conveyance body having, at its intake end, means for coupling to a flexible hose comprised within a faucet, and is associated, at its delivery end, with a disk comprising a central port and peripheral ports for water passage, characterized in that said body comprises a cavity being arranged substantially transversely to the water delivery direction and having an opening toward a duct which branches off from the water intake end and is divided into two facing portions which lie on opposite sides with respect to said opening, each portion comprising a water delivery port, one of said ports being adapted to be connected to the peripheral ports, the other port being suitable to be connected to the central water passage port that is comprised within said disk, at least one of said portions being provided with a hollow plug which comprises, at the wall, a port for connection to the water delivery port that is comprised within said portion, a flow control element being provided which has a rod which protrudes externally so as to be associated with an actuation lever, and is suitable to abut, on opposite sides, with sealing surfaces at the water intake section respectively of the portion that is not provided with the plug and of the cavity of the plug comprised within the other portion.

### BRIEF DESCRIPTION OF THE DRAWINGS

Further characteristics and advantages of the invention will become better apparent from the following detailed description of preferred but not exclusive embodiments thereof, illustrated only by way of non-limitative example in the accompanying drawings, wherein:

FIG. 1 is a view of the invention during use;

FIG. 2 is a sectional view of the invention, taken along a longitudinal plane, in the fully assembled condition;

FIG. 3 is an exploded view of the invention;

FIGS. 4, 5 and 6 are views of three successive steps of the assembly of the invention;

FIGS. 7 and 8 are, respectively, a longitudinal sectional view and an exploded view of a second embodiment according to the invention;

FIGS. 9, 10 and 11 are longitudinal sectional views of further embodiments according to the invention.

### DESCRIPTION OF THE PREFERRED EMBODIMENTS

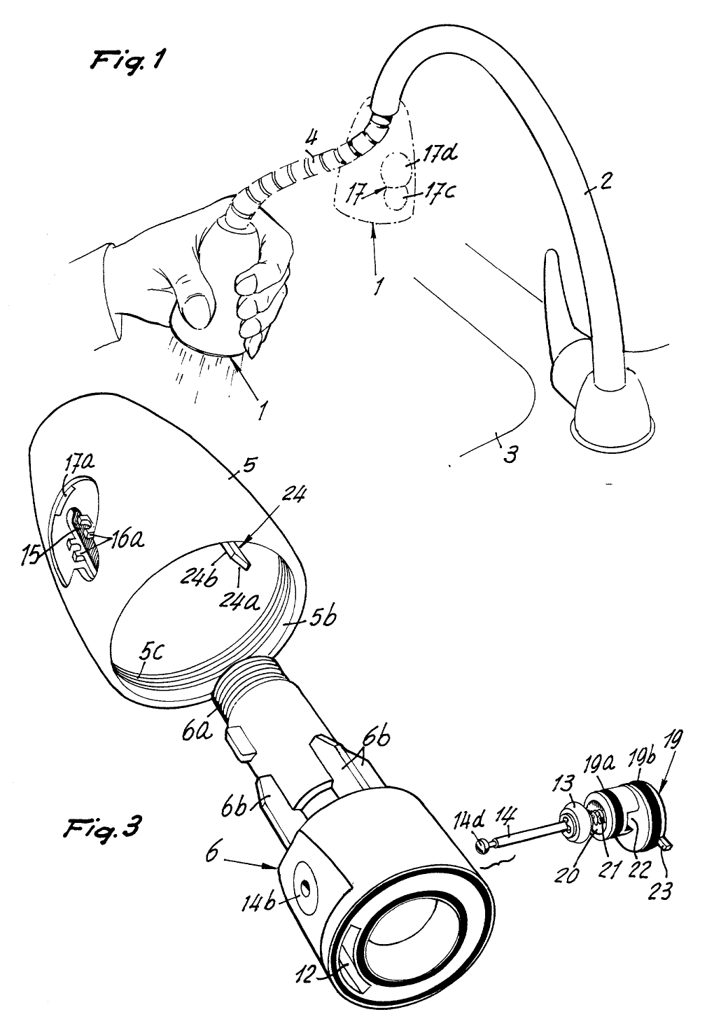

With reference to FIGS. 1 to 6, reference numeral 1 generally designates the shower head, which is shown in FIG. 1 in two positions: one position, shown in dot-and-dash lines, in which it is in contact with the end of the faucet 2 on the sink 3, and a position, shown in solid lines, in which the shower head has been gripped by a user and moved away from the faucet 2 in order to reach, with a localized jet, distant positions in the sink by taking advantage of the presence of the flexible hose 4 which is comprised within the faucet 2 and is associated, in manners described hereafter, with said shower head 1.

The shower head 1 comprises the outer enclosure 5, which is formed as a solid of revolution which allows comfortable grip by a user and has two substantially opposite openings 5a and 5b; the central body 6, meant to convey water from the intake end, which is provided with a thread 6a for coupling to the flexible hose 4, is contained and locked within said outer enclosure.

The central body 6, which has reinforcement fins such as 6b, is locked within the outer enclosure 5 by means of the disk 7, which has an external thread, is associated with said outer enclosure by means of the thread 5c, and is adapted to abut against said central body 6 at the water delivery end: the disk 7 comprises the central water delivery port 7a, which is provided with the filters and aerator set 7b, and ports such 7c, 7d to discharge of the water in the form of a peripheral jet.

The central body 6 comprises a cavity which is arranged substantially transversely to the water delivery direction and is divided into two facing portions 8 and 9 which lie on opposite sides with respect to the opening 10 which connects said cavity to the duct 11 which branches off from the water intake end.

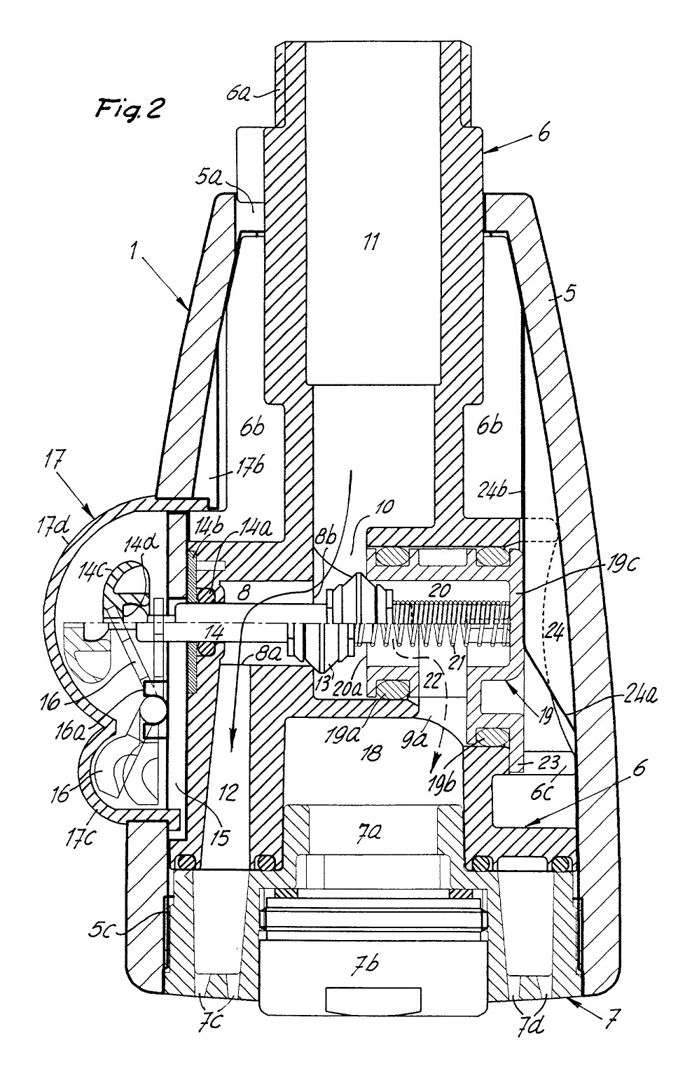

The cavity portion 8 is provided with a port 8a for the discharge of the water toward the duct 12, which is connected to the ports such as 7c, 7d of the disk 7 that provide the peripheral jet, and is shaped at the water intake section so as to form the surface 8b that provides a seal by abutment against the flow control element 13 connected to the rod 14, which is shown in FIG. 2 in two operating positions, as detailed hereinafter.

Said rod 14 protrudes from the bottom of the cavity portion 8, which is protected by the gasket 14a, which is locked by means of the plate 14b, and protrudes from the slot-shaped opening 15 which lies longitudinally along the wall of the outer enclosure 5: in this manner it is associated with the actuation lever 16, which will be described further hereinafter and is pivoted on the support 16a.

Reference numeral 17 designates a covering hood which is associated with the outer enclosure 5 by insertion of a tab provided at one end of the hood in the hole 17a, with locking on the tooth 17b, and of a tab at the other end thereof in the end region of the opening 15: said hood is made of elastic material and is shaped so as to form two regions 17c, 17d which lie respectively over the end of the lever 16 and over the button 14c, which is located at the partially spherical end of the rod 14 and is associated therewith at the flat face 14d which prevents abnormal movements: said regions are highly differentiated in terms of their dimensions, so that they can be easily recognized by the user simply by touch.

The cavity portion 9 is provided with the port 9a for delivering the water toward the portion of space 18 connected to the central port 7a of the disk 7 and is suitable to contain the movable plug or slider 19 with sealing gaskets 19a, 19b.

Said slider 19 comprises the cavity 20, which has a water intake opening delimited by the surface 20a for providing a seal by abutment against the flow control element 13 and contains the spring 21 for actuating said flow control element 13, said spring being associated with the bottom 19c of the slider; the numeral 22 furthermore designates a port which is provided in the wall of the slider 19 and is suitable to connect the cavity 20 to the water delivery port 9a, and the numeral 23 designates a tooth which protrudes from said slider in order to keep it in position during the movements described hereinafter, being able to slide within a guide 6c formed in the central body 6.

Finally, reference numeral 24 designates a ridge which protrudes from the internal surface of the wall of the outer enclosure 5 and comprises an inclined portion 24a and a longitudinal portion 24b; said ridge is suitable to move the slider 19 during the insertion, on assembly, of the central body 6 in the outer enclosure 5, in a manner described hereafter.

The per se known operation of the device for switching from the central jet to the peripheral jet and vice versa is briefly described with reference to FIG. 2, which illustrates the shower head in a fully assembled condition and in the operating position.

With the faucet closed, the spring 21 pushes the flow control element 13 against the sealing surface 8b, as shown in the lower region of FIG. 2, so as to produce the central-jet condition when the faucet opens; the water, arriving from the duct 11, in fact enters the cavity 20 of the slider 19, passing through 20a, and then reaches, by following the dashed-line path of FIG. 2 through the ports 22 and 9a, the portion of space 18 that is connected to the central port 7a of the disk 7.

If one wishes to switch the jet from central to peripheral, it is sufficient to press the button 14c, so as to move the flow control element 13 into the condition shown in the upper region of FIG. 2, i.e., in contact with the sealing surface 20a: the water traces the path shown in solid lines in FIG. 2 and the peripheral jet is produced through the ports such as 7c, 7d.

The situation is maintained by virtue of the passage of the water, and if one wishes to return to the central-jet condition it is sufficient to press the end of the lever 16, i.e., close the faucet.

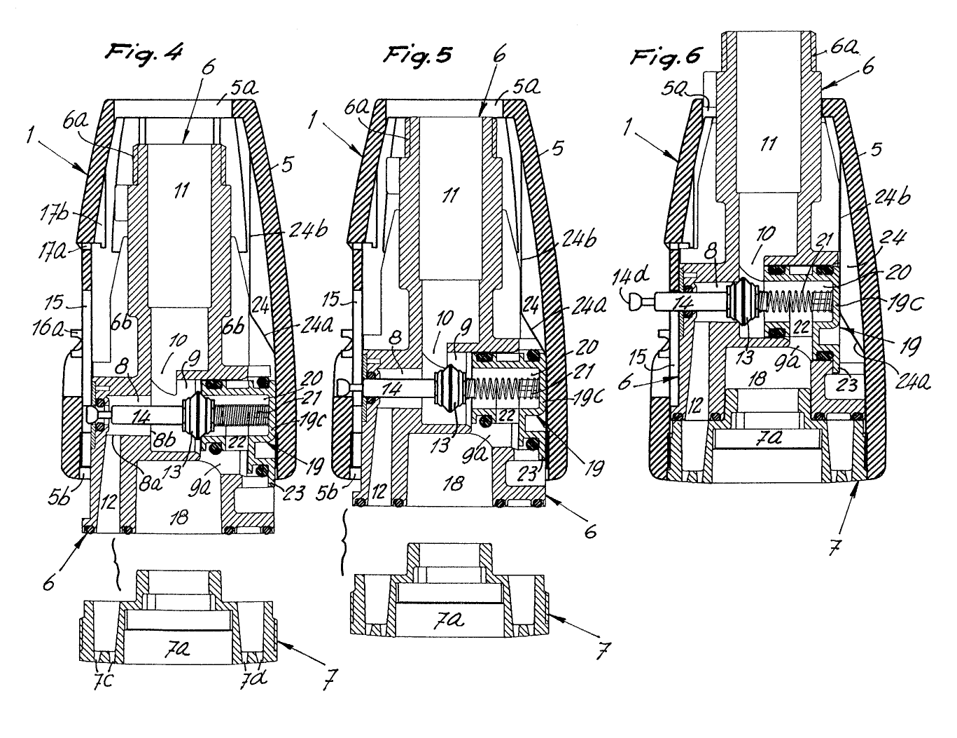

The method of assembling the shower head according to the invention is of primary interest and is now described with reference to FIGS. 4, 5 and 6.

The assembly formed by the slider 19 with the spring 21 and the flow control element 13 with the corresponding rod 14 is assembled first; then the assembly is inserted in the cavity portion 9 of the central body 6, taking care to place the end of the rod 14 at the hole provided on the bottom of the cavity portion 8, which is controlled by the gasket 14a.

At this point, the central body 6 is inserted in the outer enclosure 5, and during the first steps of insertion, such as the one shown in FIG. 4, passage is allowed by the fact that the bottom of the slider 19 and the end of the rod 14 skim the internal surface of the wall of said outer enclosure 5, in conditions of minimum axial space occupation achieved by virtue of the resiliency of the spring 21, which has assumed the maximum compression condition.

As the insertion of the central body 6 continues, one reaches the condition of FIG. 5, in which the end of the rod 14 has arranged itself at the opening 15 and can protrude from it, pushed by the spring 21.

From this moment onward, by virtue of the appropriate arrangement of the ridge 24, the further insertion of the central body 6 produces the movement of the slider 19 which, appropriately guided by the tooth 23, is pushed by the portion 24a of said ridge to the active position shown in FIG. 6, which is rendered stable by the contact of the portion 24b of the ridge with the bottom 19c of the slider, which has the tooth 23 in contact with an abutment and locking surface.

Final closure occurs by screwing the disk 7, and the operation is completed, just before fully closing said disk 7, by assembling the button 14c, the lever 16 and the hood 17.

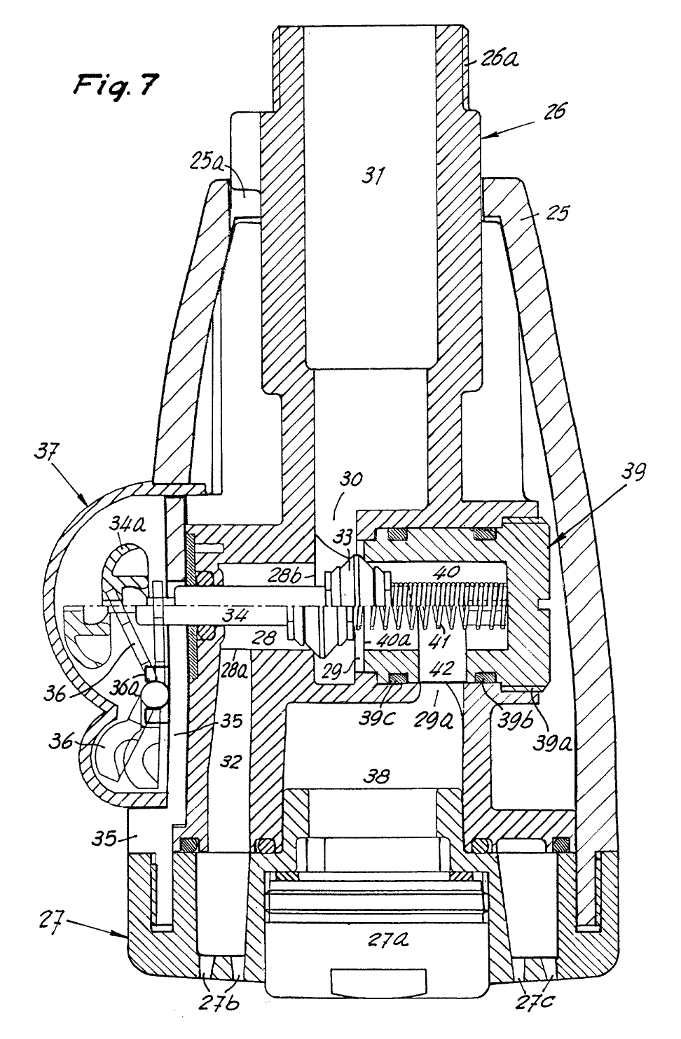

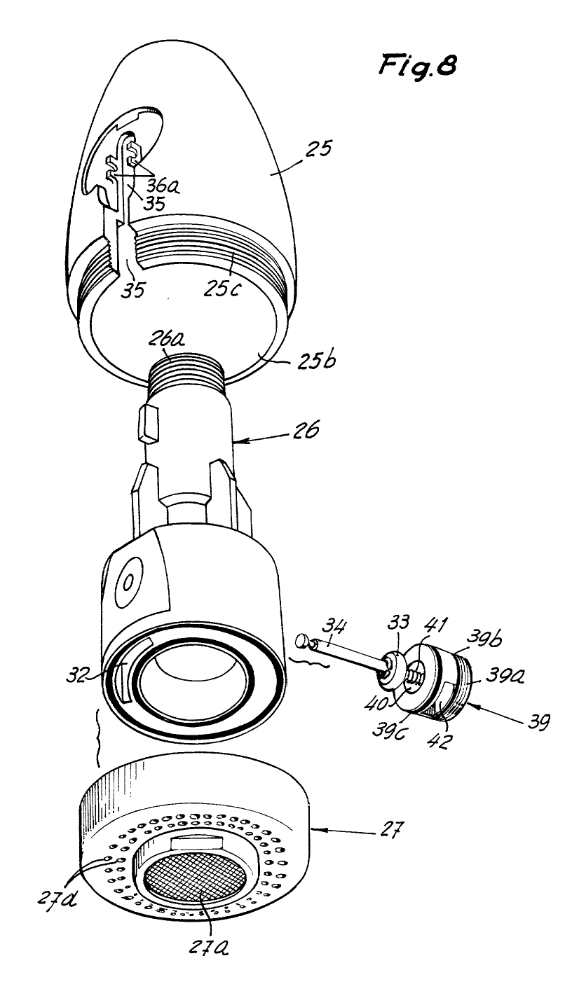

A second embodiment of the invention is now described with reference to FIGS. 7 and 8; such embodiment comprises the outer enclosure 25, which has the two mutually opposite openings 25a and 25b and internally contains the central body 26, which is adapted to convey water from the intake end, being provided with a thread 26a for coupling to a flexible hose such as 4.

The central body 26 is locked within the outer enclosure 25 by virtue of the disk 27, which is associated by means of an internal thread with the thread 25c provided on the outer surface of said enclosure and is suitable to abut with said central body 26 at the water delivery end; said disk 27 of course comprises a central water delivery port, which is provided with the filters and aerator set 27a, and ports such as 27b, 27c, 27d for providing the peripheral jet.

The central body 26 comprises, like the previously described central body 6, a cavity which is arranged substantially transversely to the water delivery direction and is divided into two facing portions 28, 29 which lie on opposite sides with respect to the opening 30 that connects said cavity to the duct 31 that branches off from the water intake end.

In a manner similar to what occurs for the previously described cavity portion 8, the cavity portion 28 has a port 28a for delivering the water toward the duct 32, which is connected to the ports such as 27b, 27c, 27d of the disk 27 that provide the peripheral jet, and is shaped at the water intake section so as to form the surface 28b for providing a seal by abutment with the flow control element 33 connected to the rod 34, which is fully identical to the flow control element 13 of the previously described embodiment.

Said rod 34 protrudes from the bottom of the cavity portion 28 and protrudes from the opening 35 that lies longitudinally on the wall of the outer enclosure 25 in the form of a notch which is open at the opening 25b of said enclosure; in this manner, the rod is associated with the actuation lever 36 which is pivoted to the support 36a and is covered, together with the button 34a arranged at the end of said rod, by the hood made of elastic material 37, all as described with reference to the first embodiment.

The cavity portion 29 is provided with the port 29a for delivering the water toward the portion of space 38 that is connected to the central port of the disk 27 and is suitable to contain the fixed plug 39, which is associated therewith by virtue of the thread 39a and is provided with the sealing gaskets 39b, 39c.

Said plug 39 comprises the cavity 40, which has a water intake opening which is delimited by the surface 40a for forming a seal by abutment with the flow control element 33, and contains the spring 41, associated with the bottom, for the actuation of said flow control element 33; reference numeral 42 furthermore designates a port which is provided in the wall of the fixed plug 39 and is suitable to connect the cavity 40 to the water delivery port 29a.

The assembly of this embodiment of the invention first of all entails forming the assembly that comprises the plug 39 with the spring 41 and the flow control element 33 with the corresponding rod 34 and screwing said plug 39 into the seat formed within the portion of cavity 29 of the central body 6.

At this point, the central body 26 is inserted in the outer enclosure 25 and is moved to the operating condition shown in FIG. 7 without encountering any obstacle, since the rod 34 enters and slides in the notch 35, which is open at the end.

Final closure occurs by screwing the disk 27, which by surrounding from the outside the enclosure 25 ensures its absolute compactness, and the operation is completed, before fully tightening the disk, by assembling the button 34a, the lever 36 and the hood 37.

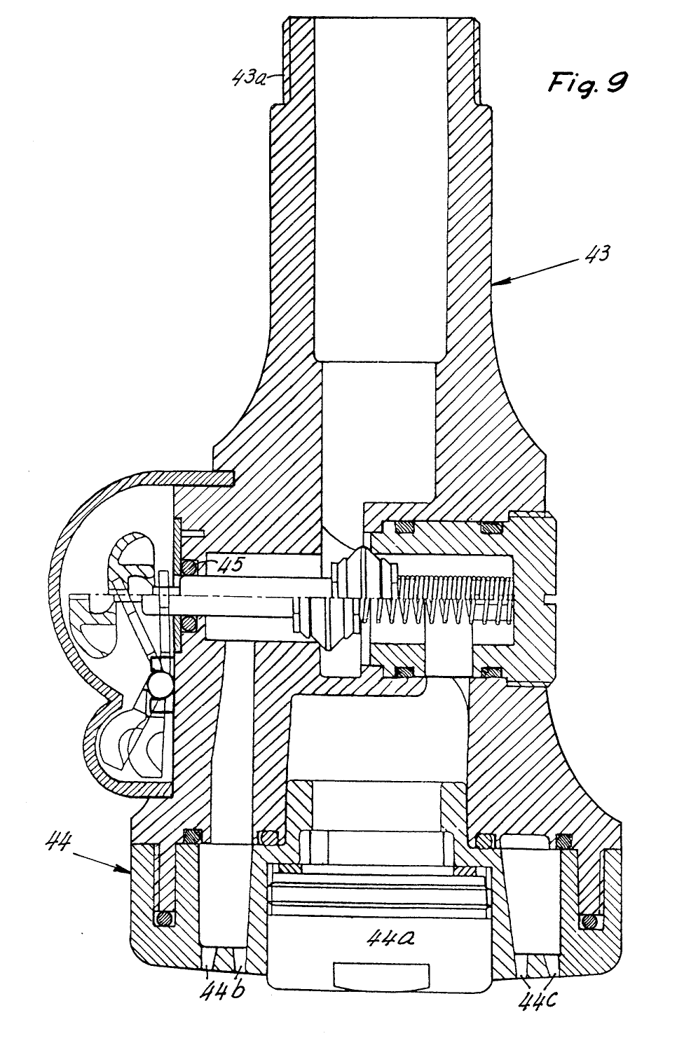

A third embodiment of the invention is now described with reference to FIG. 9 and comprises the water conveyance body 43, which is provided at its intake end with a thread 43a for coupling to a flexible hose such as 4 and with which the disk 44 is associated by means of a thread at the delivery end; said disk has a central port, which is provided with the filters and aerator set 44a, and ports such as 44b, 44c for providing the peripheral jet.

Said body 43 internally has a configuration which is fully similar to the configuration of the central body 26 of the previously described variation, and this is true also for the elements associated therewith, such as the flow control element with the corresponding rod, the fixed plug for the abutment of the contrast spring of said flow control element, and the hood for covering the actuation lever; it is merely noted that in this embodiment said rod of the flow control element protrudes from the body 43, passing through a circular hole protected by the gasket 45.

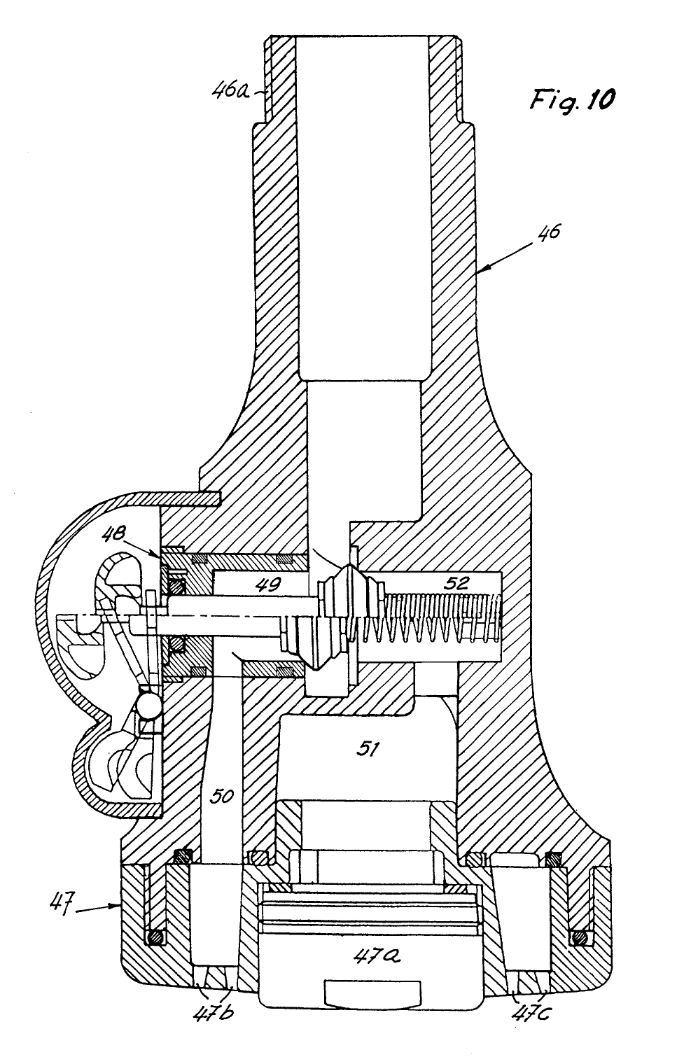

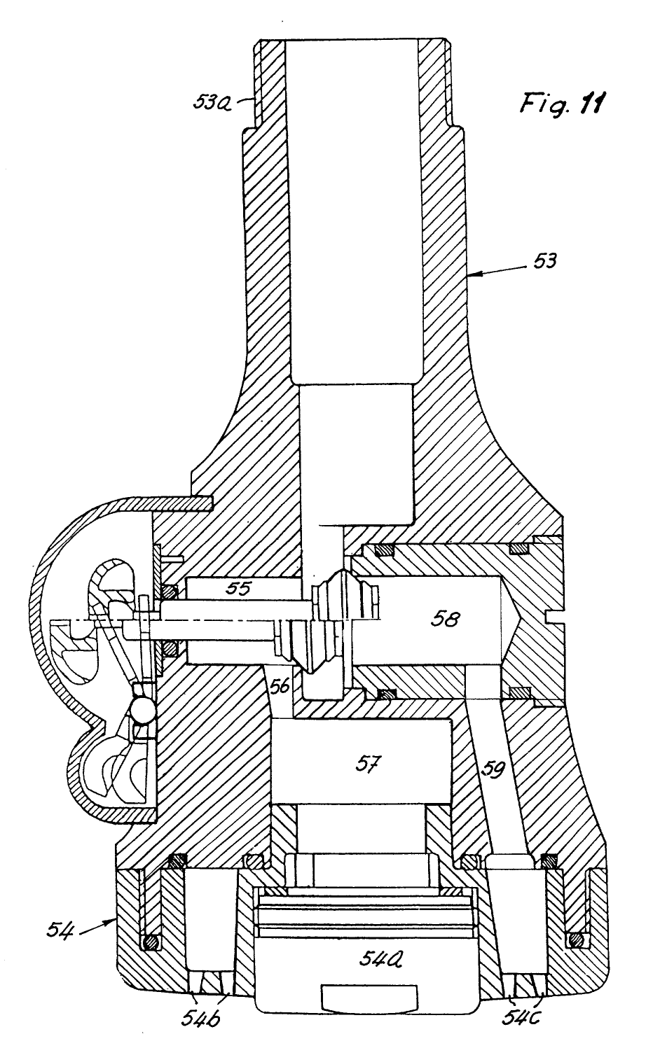

A fourth embodiment of the invention is described with reference to FIG. 10; such fourth embodiment comprises the water conveyance body 46, with a thread 46a at the intake end, and is provided, at the delivery end, with the disk 47, which has a central port provided with the filters and aerator set 47a, and ports such as 47b, 47c for providing the peripheral jet.

The configuration of the body 46 is fully similar to the configuration of the body 43 shown in FIG. 9, the only change being the fact that the plug 48 is located at the bottom of the portion 49 of the transverse cavity from which the rod of the flow control element protrudes, without altering the fact that said cavity portion is connected to the duct 50 which conveys water to the disk 47 in order to form the peripheral jet, while the water for forming the central jet reaches the portion of space 51 by arriving from the transverse cavity portion 52 whose bottom is formed monolithically within the body 46.

The shape and operation of the flow control element of course remain unchanged.

A placement of the plug 48 such as the one described might also be provided in the embodiment shown in FIG. 7 described earlier.

The embodiment shown in FIG. 11, described hereafter, comprises the water conveyance body 53, which has a thread 53a at the intake end and is provided, at its delivery end, with the disk 54 with a central port provided with the filters and aerator set 54a, and with ports such as 54b, 54c for providing the peripheral jet.

The modification that the body 53 has with respect to the body 43 described in FIG. 9 consists in that the transverse cavity portion 55 from the bottom of which the rod of the flow control element protrudes is connected, by means of the duct 56, to the portion of space 57 that conveys the water to the central jet, while the portion 58 of said transverse cavity is connected, by means of the duct 59, to the holes of the disk 54 that form the peripheral jet.

A modification such as the one described above with regard to the embodiment shown in FIG. 9 can also be performed in the embodiments shown in FIGS. 2, 7 and 10, and this is true also for the further modification that can be noticed in FIG. 11, which consists of the absence of the actuation spring of the flow control element, which is otherwise unchanged.

The described invention is susceptible of numerous other modifications and variations, all of which are within the scope of the inventive concept; all the details may further be replaced with other technically equivalent elements.

The disclosures in Italian Patent Application No. MN2000A000013 from which this application claims priority are incorporated herein by reference.

What is claimed is:

1. A pull-out shower head for kitchen, comprising: a central water conveyance body; coupling means, provided at a water intake end of the body, for coupling to a flexible hose accommodatable within a faucet; a disk provided at a water delivery end of the body, and including a central port and peripheral ports for water passage; a cavity of said body, which is arranged substantially transversely to a water delivery direction; a duct which branches off from said intake end, said cavity having an opening toward said duct and being divided into two facing portions which lie on opposite sides with respect to said opening, each said portion comprising a water delivery port thereof, a first one of said water delivery ports being connectable to said peripheral ports, and a second one of said water delivery ports being connectable to said central port for water passage that is comprised within said disk; a hollow plug being provided at a first one of said portions, said hollow plug comprising at a wall portion thereof, a connection port for connection to said water delivery port that is comprised within said first portion; and a flow control element having a rod which protrudes externally and an actuation lever connected to said rod, said flow control element being actuatable to abut, on opposite sides thereof, with sealing surfaces provided respectively, at a water intake section of a second one of said portions and at a face of a cavity of the hollow plug comprised within the first portion.

2. The shower head of claim 1, further comprising an outer enclosure provided with two openings, said central water conveyance body being contained within the outer enclosure in order to be locked therein by way of said disk located at the water delivery end, the disk being further connected to a first one of said openings of said outer enclosure, said central body being provided, at the water intake end which is located at the second one of said openings, with said coupling means for coupling to the flexible hose.

3. The shower head of claim 2, further comprising: a button located at an end of said rod, and a hood for covering the actuation lever of the rod of the flow control element, said hood being made of elastic material and being shaped so as to form two regions which have differentiated dimensions and lie over the end of said lever and over said button, respectively.

4. The shower head of claim 3, wherein said hood for covering the lever for actuating the rod of the flow control element is provided with end tabs which are insertable in appropriately provided openings of said outer enclosure in order to lock the hood.

5. The shower head of claim 4, wherein said button has a flat face, and said rod of the flow control element has an end which is partially spherical and includes an end flat face which makes contact with said flat face provided at the button so as to prevent abnormal movements thereof.

6. The shower head of claim 2, further comprising a protection gasket located at a passage hole of said second portion for outward passage of said rod of the flow control element; and a locking plate coupled with a surface adjacent to said passage hole for locking said gasket.

7. The shower head of claim 6, comprising a flow control element actuation spring.

8. The shower head of claim 2, wherein said outer enclosure has an outer shape formed so as to enable comfortable hand gripping.

9. The shower head of claim 8, wherein said outer enclosure is shaped as a solid of revolution with said two openings located at opposite bases thereof.

10. The shower head of claim 2, wherein said disk locks the central water conveyance body within said outer enclosure by screwing on a thread located at an opening of said outer enclosure, said disk further accommodating a filter and aerator set arranged at said central water passage port thereof.

11. A shower head comprising: an outer enclosure provided with two openings; a central water conveyance body containable within the outer enclosure; an abutment disk located at a first water delivery end of the outer enclosure for locking said central body within said outer enclosure, said disk being connected to a first one of said openings of said outer enclosure and comprising a central port and peripheral ports for water passage, said central body being provided, at a second end for water intake of said outer enclosure, located at a second one of said openings thereof, with coupling means for coupling to a flexible hose which is comprised within a faucet; a duct which branches off from the water intake end; a cavity of said central body, which is arranged substantially transversely to a water delivery direction, is provided with a cavity opening toward said duct and is divided into a first and a second facing portions which lie on opposite sides with respect to said cavity opening; a flow control element; a rod connected to said flow control element so as to protrude from a bottom of said first portion through a longitudinal opening which lies longitudinally on a wall of said outer enclosure; an actuation lever connected to said rod; a plug, accommodated in said second portion, which comprises a plug cavity having, at one end, a water intake cavity opening delimited by a surface for forming a seal by abutment against said flow control element; and a spring accommodated in said plug cavity for actuating said flow control element, and wherein
said first portion is provided with a water delivery port which is connectable to the peripheral water passage ports of said abutment disk and is shaped, at the water intake section, so as to form a surface for sealing by abutment against said flow control element; and
said second portion is provided with a water delivery port which is connectable to the central water passage port of said abutment disk and accommodates said plug, and comprises, at a wall part thereof, a connection port for connection to said control water passage port for water delivery from the second portion.

12. The shower head of claim 11, further comprising a ridge which protrudes from an internal surface of the wall of said outer enclosure; and a lateral opening that lies longitudinally on the wall of the outer enclosure and is slot-shaped so as to allow protrusion of the rod of the flow control element, said plug being constituted by any of a movable plug and a slider, which is movable during insertion of the central body in the outer enclosure in order to be placed in an active position and be locked thereat by said ridge.

13. The shower head of claim 12, wherein said abutment disk is associated, through a thread provided at its outer surface, with one of said two openings of said outer enclosure.

14. The shower head of claim 12, wherein the slider is provided with a tooth which is arrangeable into an active position in contact with an abutment surface formed within the central body, by moving within a guide formed in said central body.

15. The shower head of claim 14, wherein the ridge that protrudes from the internal surface of the wall of the outer enclosure makes contact with a bottom part of the slider and has:
a first portion, which is inclined so as to allow movement of said slider until the active position is reached during insertion of the central body in the outer enclosure from a position in which the bottom part of said slider is in contact with said internal surface, said first inclined portion being arranged so as to determine beginning of said movement substantially from a position of the central body in which the rod of the flow control element protrudes from the lateral opening that lies longitudinally on said wall of the outer enclosure; and
a second portion, which is longitudinal for arrangement thereof in contact with the bottom part of the slider in the active position.

16. The shower head of claim 11, wherein said plug is a fixed plug, the outer enclosure having a lateral opening that lies longitudinally along an outer surface thereof, said lateral opening being formed as a notch which is open at the water delivery end in order to allow the rod of the flow control element to protrude, the abutment disk having an internal thread which is complementary to a thread formed on the outer surface of said outer enclosure whereby to lock the central body by screwing within the outer enclosure.

17. The shower head of claim 16, wherein the fixed plug is connected to the second cavity portion by way of a thread.

18. The shower head of claim 16, wherein the fixed plug is connected to the second portion of cavity by forced keying.

19. A kitchen shower head for connection to a flexible hose comprised within a faucet, comprising: a central water conveyance body; coupling means located at an intake end of the central body for coupling to the flexible hose; a disk connected to a thread provided proximate to a delivery end of said central body, said disk having a central port and peripheral ports for water passage; a duct which branches off from the water intake end, said body comprising a cavity which is arranged substantially transversely to a water delivery direction and provided with a cavity opening toward said duct, said cavity being divided into two facing portions which protrude on opposite sides with respect to said cavity opening, each one of said portions comprising a water delivery port, a first one of said ports being connectable to the peripheral ports, a second one of said ports being instead connectable to the central water passage port comprised within said disk; a fixed hollow plug accommodated within a first one of said portions, said plug comprising at a wall part thereof, a plug port for connection to the water delivery port comprised within said first portion; a flow control element arranged so as to abut, on opposite sides thereof, against sealing surfaces at the water intake section of, respectively, a second one of said portions free from said plug and the plug cavity that is comprised in the first portion; an actuation lever; and a rod which protrudes outward from said outer enclosure so as to be connected to the actuation lever.
